(19) United States
(12) Patent Application Publication
(10) Pub. No.: US 2026/0367810 A1
(43) Pub. Date: Nov. 19, 2026

(54) System and Method for Policy-driven Management of Back-end Storage Fabrics

(71) Applicant: Dell Products L.P., Round Rock, TX (US)

(72) Inventors: Prakash Venkatanarayanan, Millbury, MA (US); Matthew H. Long, Pocasset, MA (US); Hari Prasad Chandrasekaran, Bangalore (IN); Dharanendra Hesi, Cary, NC (US); Ankita Rai, Bangalore (IN)

(21) Appl. No.: 19/208,046

(22) Filed: May 14, 2025

(51) Int. Cl. G06F 3/06

(52) U.S. Cl. CPC G06F 3/0629; G06F 3/0604; G06F 3/0683

(57) ABSTRACT

A method, computer program product, and computing system for discovering a plurality of storage processors connected to a storage fabric that are accessible to an initiating back-end storage processor of a storage system. A selection for a storage policy associated with the plurality of storage processors that are accessible to the initiating back-end storage processor is processed. Connections between the plurality of storage processors and the initiating back-end storage processor are configured based upon, at least in part, the selected storage policy.

### BACKGROUND

Storing and safeguarding electronic content may be beneficial in modern business and elsewhere. Accordingly, various methodologies may be employed to protect and distribute such electronic content.

For example, in a storage fabric, storage processors are connected directly and/or across switches according to a particular fabric protocol (e.g., Fibre Channel, Non-volatile Memory over Fabric (NVMe-oF), etc.). In this configuration, storage arrays perform dual roles both as storage targets and initiators that connect to other storage targets. With conventional discovery and connection processes, all initiators are connected to all targets, causing scale and performance issues. Even in situations involving a selective connection to particular targets, a storage administrator on host, wishing to manage a particular back-end storage processor, is unable to ascertain storage processors that are accessible to the back-end storage processor within the storage system and manage the connections from that back-end storage processor across the storage fabric.

### SUMMARY OF DISCLOSURE

In one example implementation, a computer-implemented method executed on a computing device may include, but is not limited to, discovering a plurality of storage processors connected to a storage fabric that are accessible to an initiating back-end storage processor of a storage system. A selection for a storage policy associated with the plurality of storage processors that are accessible to the initiating back-end storage processor is processed. Connections between the plurality of storage processors and the initiating back-end storage processor are configured based upon, at least in part, the selected storage policy.

One or more of the following example features may be included. A user is enabled to manage the plurality of storage processors connected to the storage fabric that are accessible to the initiating back-end storage processor. A selection of a subset of storage processors from the plurality of storage processors may be processed. Configuring the connections between the plurality of storage processors and the initiating back-end storage processor may include configuring connections between the subset of storage processors and the initiating back-end storage processor. The storage policy may configure the connections between the plurality of storage processors and the initiating back-end storage processor for high-availability. The storage policy may configure the connections between the plurality of storage processors and the initiating back-end storage processor for scaling a number of connections per storage processor. The storage system may be a Fibre Channel (FC) Storage Area Network (SAN).

In another example implementation, a computer program product resides on a computer readable medium that has a plurality of instructions stored on it. When executed by a processor, the instructions cause the processor to perform operations that may include, but are not limited to, discovering a plurality of storage processors connected to a storage fabric that are accessible to an initiating back-end storage processor of a storage system. A selection for a storage policy associated with the plurality of storage processors that are accessible to the initiating back-end storage processor is processed. Connections between the plurality of storage processors and the initiating back-end storage processor are configured based upon, at least in part, the selected storage policy.

One or more of the following example features may be included. A user is enabled to manage the plurality of storage processors connected to the storage fabric that are accessible to the initiating back-end storage processor. A selection of a subset of storage processors from the plurality of storage processors may be processed. Configuring the connections between the plurality of storage processors and the initiating back-end storage processor may include configuring connections between the subset of storage processors and the initiating back-end storage processor. The storage policy may configure the connections between the plurality of storage processors and the initiating back-end storage processor for high-availability. The storage policy may configure the connections between the plurality of storage processors and the initiating back-end storage processor for scaling a number of connections per storage processor. The storage system may be a Fibre Channel (FC) Storage Area Network (SAN).

In another example implementation, a computing system includes at least one processor and at least one memory architecture coupled with the at least one processor, wherein the at least one processor is configured to discover a plurality of storage processors connected to a storage fabric that are accessible to an initiating back-end storage processor of a storage system. A selection for a storage policy associated with the plurality of storage processors that are accessible to the initiating back-end storage processor is processed. Connections between the plurality of storage processors and the initiating back-end storage processor are configured based upon, at least in part, the selected storage policy.

One or more of the following example features may be included. A user is enabled to manage the plurality of storage processors connected to the storage fabric that are accessible to the initiating back-end storage processor. A selection of a subset of storage processors from the plurality of storage processors may be processed. Configuring the connections between the plurality of storage processors and the initiating back-end storage processor may include configuring connections between the subset of storage processors and the initiating back-end storage processor. The storage policy may configure the connections between the plurality of storage processors and the initiating back-end storage processor for high-availability. The storage policy may configure the connections between the plurality of storage processors and the initiating back-end storage processor for scaling a number of connections per storage processor. The storage system may be a Fibre Channel (FC) Storage Area Network (SAN).

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a storage fabric management process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the storage fabric management process of FIG. 1 according to one or more example implementations of the disclosure;

FIGS. 4-5 are example diagrammatic views of the storage fabric management process of FIG. 1 according to various example implementations of the disclosure; and

FIG. 6 is an example diagrammatic view of a graphical user interface of the storage fabric management process of FIG. 1 according to one or more example implementations of the disclosure.

Like reference symbols in the various drawings indicate like elements.

### DETAILED DESCRIPTION

### System Overview:

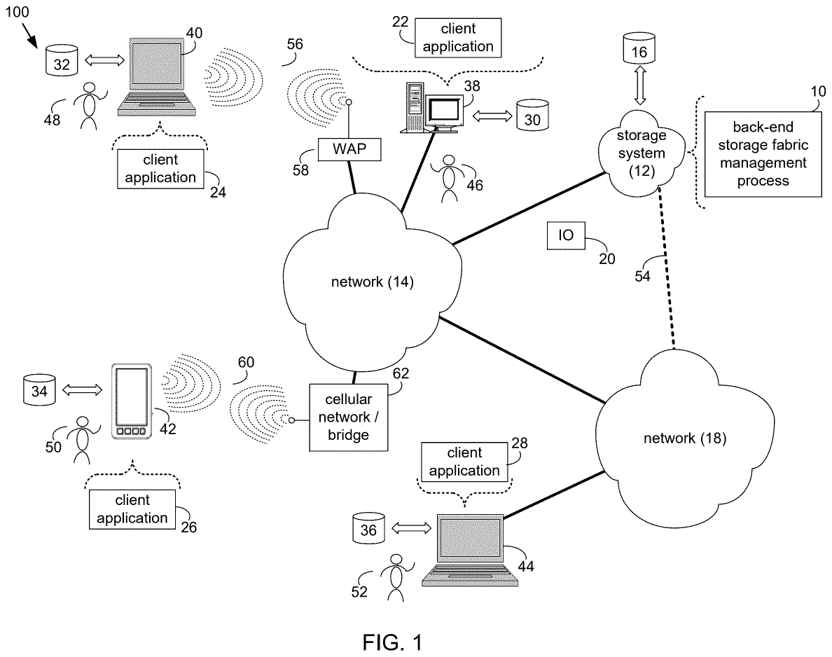

Referring to FIG. 1, there is shown back-end storage fabric management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of back-end storage fabric management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of back-end storage fabric management process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an storage fabric management process, such as back-end storage fabric management process 10 of FIG. 1, may include but is not limited to, discovering a plurality of storage processors connected to a storage fabric that are accessible to an initiating back-end storage processor of a storage system. A selection for a storage policy associated with the plurality of storage processors that are accessible to the initiating back-end storage processor is processed. Connections between the plurality of storage processors and the initiating back-end storage processor are configured based upon, at least in part, the selected storage policy.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

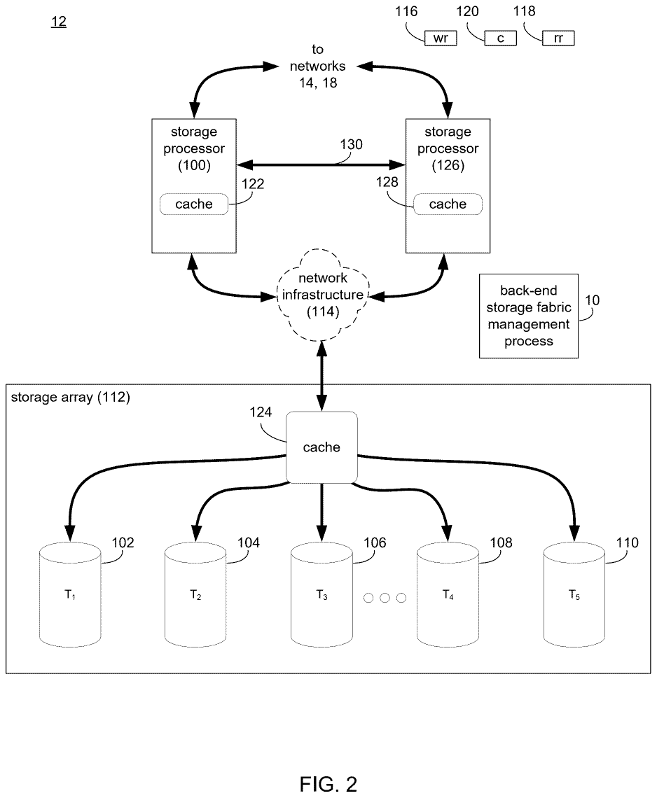

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of back-end storage fabric management process 10. The instruction sets and subroutines of back-end storage fabric management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of back-end storage fabric management process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of back-end storage fabric management process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of back-end storage fabric management process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of back-end storage fabric management process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of back-end storage fabric management process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### The Back-End Storage Fabric Management Process

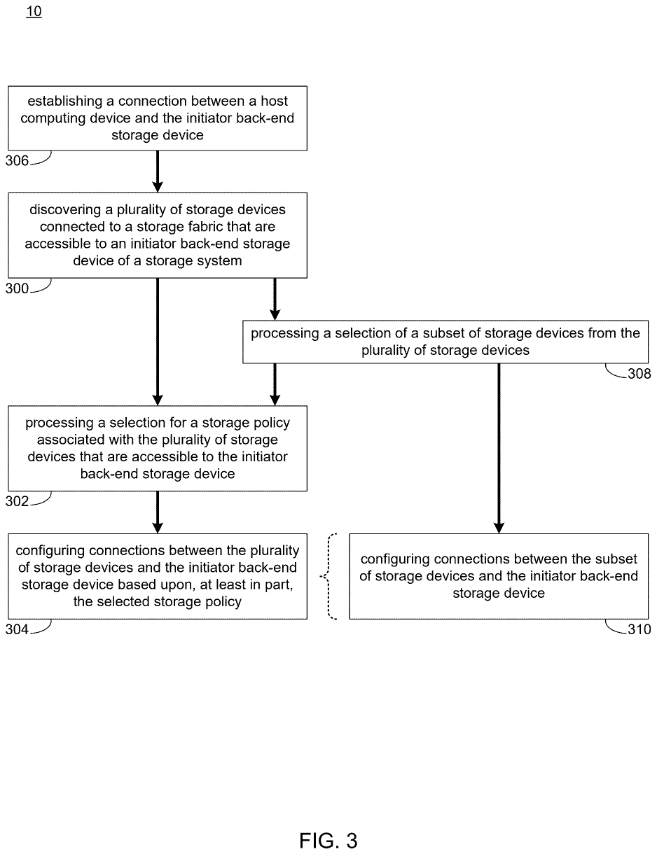

Referring also to FIGS. 3-5 and in some implementations, back-end storage fabric management process 10 discovers 300 a plurality of storage processors connected to a storage fabric that are accessible to an initiating back-end storage processor of a storage system. A selection for a storage policy associated with the plurality of storage processors that are accessible to the initiating back-end storage processor is processed 302. Connections between the plurality of storage processors and the initiating back-end storage processor are configured 304 based upon, at least in part, the selected storage policy.

For example, in a storage fabric, storage processors are connected directly and/or across switches according to a particular fabric protocol (e.g., SCSI over Fibre Channel (FC), NVMe-oF/FC, etc.). In this configuration, storage arrays perform dual roles both as storage targets and initiators that connect to other storage targets. With conventional discovery and connection processes, all initiators are connected to all targets, causing scale and performance issues. Even in situations involving a selective connection to particular targets, a storage administrator on host, wishing to manage a particular back-end storage processor, is unable to ascertain storage processor that are accessible to the back-end storage processor within the storage system and manage the connections from that back-end storage processor across the storage fabric.

Implementations of the present disclosure allow users (e.g., storage administrators) to view all discovered targets of a back-end storage fabric and to execute a policy-driven approach for managing the back-end fabric (e.g., in terms of number of connections, load balancing constraints, etc.). In some implementations, back-end storage fabric management process 10 makes it possible for a storage administrator to achieve policy-driven back-end fabric management. Additionally, back-end storage fabric management process 10 allows a user to select desired number of initiator ports and target ports from the storage system, to connect with remote targets for achieving efficient point-to-point connection. Further, back-end storage fabric management process 10 provides the user with the ability to select and implement a policy that automatically selects targets and manages the back-end connections (e.g., in terms of the number of paths and setup policies, like round-robin for load-balancing, and other connection configurations).

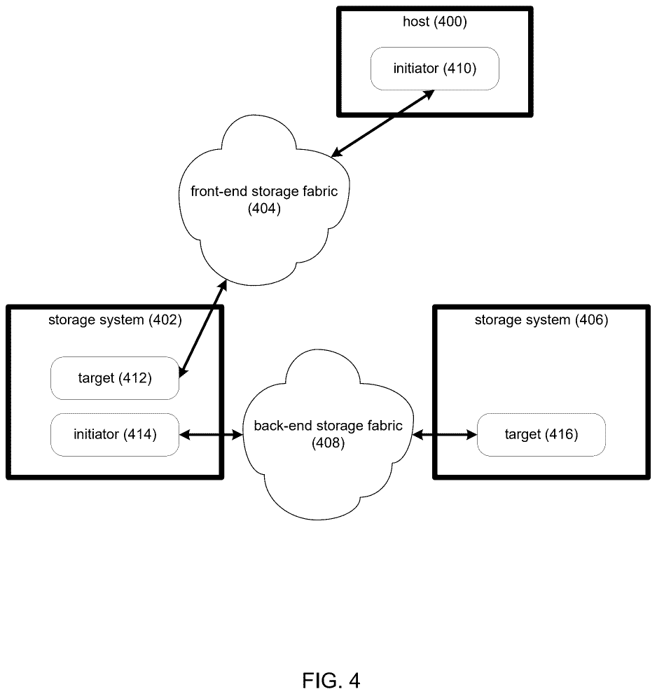

In some implementations and referring also to FIG. 4, a plurality of storage systems are configured with a storage fabric. A storage fabric is a network architecture designed to connect storage devices to servers and hosts. In one example, the portion of the storage fabric that couples front-end devices (e.g., host 400) with back-end storage systems (e.g., storage system 402) is referred to as front-end storage fabric 404. The portion of the storage fabric that couples back-end storage systems (e.g., storage systems 402, 406) is referred to as back-end storage fabric 408. The storage fabric (e.g., front-end storage fabric 404 and back-end storage fabric 408) provides a high-speed, reliable, and scalable method for data transfer between these components. Storage fabrics are essential in data centers and enterprise environments where large volumes of data need to be managed efficiently. Fibre Channel is an example of the storage fabric. It is a high-speed network technology primarily used for storage networking. Fibre Channel provides a dedicated, high-performance pathway for data transfer, which is crucial for applications requiring fast and reliable access to large datasets, such as databases and virtualized environments.

Accordingly and in one example, storage fabrics 404, 408 and storage systems (e.g., storage system 402, 406) define a Fibre Channel (FC) Storage Area Network (SAN) with a host (e.g., host 400). While the example of FIG. 4 includes two storage systems (e.g., storage systems 402, 406), it will be appreciated that this is for example purposes only and that any number of storage devices may be deployed within the storage fabric within the scope of the present disclosure. Additionally, while an example of Fibre Channel has been described for the storage fabric, it will be appreciated that other types of storage fabrics (e.g., NVMe-oF, Internet Small Computer Systems Interface (iSCSI), InfiniBand, etc.) may be used within the scope of the present disclosure.

In some implementations, in a storage fabric, devices can be initiators and/or targets. In one example, host 400 initiates a connection to back-end storage system 402 across front-end storage fabric 404. In this example, host 400 is the initiator (e.g., initiator 500) and back-end storage system 402 is the target (e.g., target 502) where data is communicated across front-end storage fabric 404 from host 400 to back-end storage system 402. In another example, data is migrated from one back-end storage system to another. Accordingly and in this example, back-end storage system 402 is configured by storage fabric management process 10 to be the initiator (i.e., initiator 414) and back-end storage system 406 is configured to be the target (e.g., target 416). In some implementations, storage fabric management process 10 discovers the target storage devices that are accessible to back-end storage device 402. As the storage devices that are accessible to host 400 may be different than the storage devices accessible to initiator 414 of back-end storage system 402, storage fabric management process 10 discovers storage devices that are accessible to initiator 414 of back-end storage system 402. In some implementations, initiator 414 and target 416 are software and/or hardware components that configure connections between storage systems and hosts.

In some implementations, back-end storage fabric management process 10 enabling 306 a user to manage the plurality of storage processors connected to the storage fabric that are accessible to the initiating back-end storage processor. For example, a user may desire to manage a back-end storage system (e.g., back-end storage systems 402, 406). As will be discussed in greater detail below, a listing of storage processors connected to storage fabric 400 that are accessible to back-end storage system 402 and a list of storage policies that can be implemented using the storage processors connected to storage fabric 400 that are accessible to back-end storage system 402.

In some implementations, back-end storage fabric management process 10 discovers 300 a plurality of storage processors connected to a storage fabric that are accessible to an initiating back-end storage processor. For example and as discussed above, in a storage fabric, storage processors can be initiators and targets. In one example, a storage processor of host 400 initiates a connection to back-end storage systems 402, 406. In this example, the storage processor of host 400 is the initiator and storage processors of back-end storage systems 402, 406 are targets where data is communicated across storage fabric 400 from host 400 to back-end storage system 402 and/or back-end storage system 406. In another example, data is migrated from one back-end storage processor to another. Accordingly, a storage processor of back-end storage system 402 is configured by back-end storage fabric management process 10 to be the initiator (i.e., initiating back-end storage processor) and back-end storage fabric management process 10 discovers 300 the target storage processors that are accessible to the initiating back-end storage processor. As the storage processors that are accessible to the storage processor of host 400 may be different than the storage processors accessible to the initiating back-end storage processor, back-end storage fabric management process 10 discovers 300 storage processors that are accessible to the initiating back-end storage processor.

In some implementations, discovering 300 storage processors that are accessible to initiating back-end storage processor includes processing any existing listing of storage processors accessible to the initiating back-end storage processor. In the example of Fibre Channel, back-end storage fabric management process 10 discovers 300 storage processors through a process called “fabric login” (FLOGI). When a storage processor is connected to a Fibre Channel storage fabric, the storage processor sends a FLOGI request to the fabric's switch (e.g., switch 500 and/or switch 502). The switch assigns a unique address to the storage processor and updates the fabric's name server with the storage processor's information, making it discoverable by other devices in the network. While an example of Fibre Channel has been discussed, it will be appreciated that discovery processes for other types of storage fabrics (e.g., SCSI over FC, NVMe over FC, etc.) are within the scope of the present disclosure.

In some implementations, the discovery responses described above can be fine-tuned by processing one or more filters to query. For example, a user may specify that for a given initiator, certain storage processors should be sought or ignored, storage processors of a particular vendor or product type should be sought or ignored, certain numbers of storage processors should be sought, etc. In this manner, back-end storage fabric management process 10 may limit the scale of discovered storage processors using the one or more filters. In some implementations, the filters may include default constraints (e.g., vendors, types, numbers of storage processors, etc.) and/or user-defined constraints. In this manner, a user with connection 408 to the initiating back-end storage processor can discover 300 storage processors that are accessible to the initiating back-end storage processor.

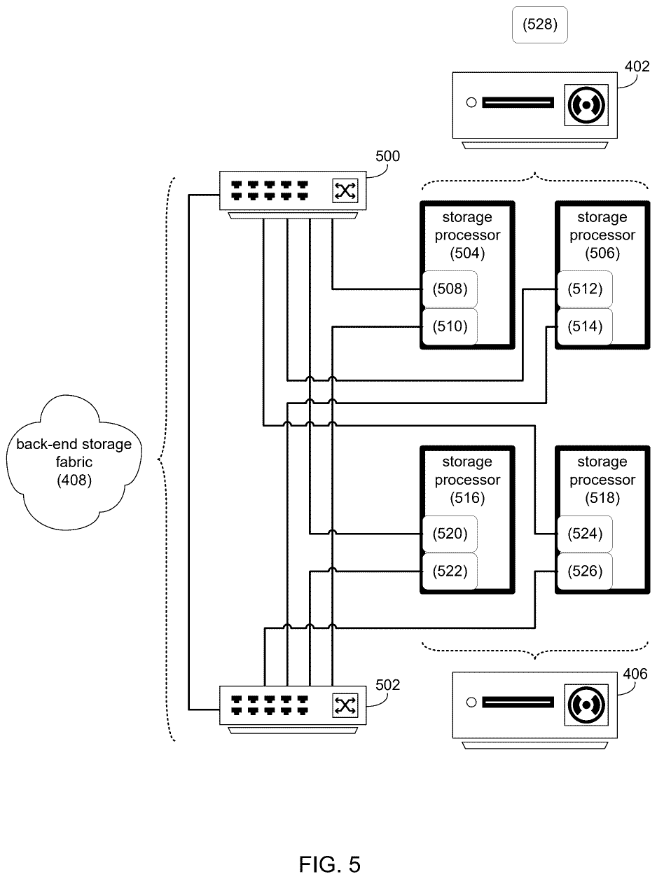

In the example of FIG. 5, back-end storage fabric management process 10 discovers 300 a plurality of storage processors accessible to the initiating back-end storage processor of storage system 402. As shown in FIG. 5, back-end storage fabric management process 10 discovers switches 500, 502 and storage system 406 with the connections and ports as described below. For example, storage system 402 includes two storage processors (e.g., storage processors 504, 506) each with e.g., two ports (e.g., ports 508, 510 of storage processor 504 and ports 512, 514 of storage processor 506) and storage system 406 includes two storage processors (e.g., storage processors 516, 518) each with e.g., two ports (e.g., ports 520, 522 of storage processor 516 and ports 524, 526 of storage processor 518). As shown in FIG. 5, port 508 of storage processor 504 and port 512 of storagestorage system 402, and port 520 of storage processor 516 and port 524 of storage processor 518 of storage system 406 are connected by switch 500. Similarly, port 510 of storage processor 504 and port 514 of storagestorage system 404, and port 522 of storage processor 516 and port 526 of storage processor 518 of storage system 406 are connected by switch 502. In this example, storage processor 504 is the initiating back-end storage processor. As will be discussed in greater detail below, back-end storage fabric management process 10 provides these ports and connections with the information concerning the plurality of storage processors discovered by back-end storage fabric management process 10 for configuring connections according to a storage policy.

In some implementations, back-end storage fabric management process 10 processes 308 a selection of a subset of storage processors from the plurality of storage processors. In one example and as discussed above, the selection of a subset of storage processors can occur before or during the discovery of storage processors using the one or more filters. In another example, back-end storage fabric management process 10 provides the results of the discovery process as a listing of storage processors that are accessible to initiating back-end storage processor 504. For instance, back-end storage fabric management process 10 may provide a graphical user interface to the user with the listing of storage processors that are accessible to initiating back-end storage processor 504 as discovered by back-end storage fabric management process 10.

In some implementations, back-end storage fabric management process 10 processes 302 a selection for a storage policy associated with the plurality of storage processors that are accessible to the initiating back-end storage processor. For example, a storage policy is a set of rules and configuration constraints that dictate how data is stored, managed, and accessed between the initiating back-end storage processor and the plurality of storage processors accessible to initiating back-end storage processor 504 (e.g., storage system 406). In some implementations, storage policies (e.g., storage policy 528) are defined to ensure that data is stored efficiently, securely, and in a manner that meets the specific needs of an organization. Storage policies can cover various aspects, including data retention, which specifies how long data should be kept before it is archived or deleted, important for compliance with legal and regulatory requirements. Storage policy 528 may also outline data protection measures for backup, replication, and recovery to protect against data loss or corruption. Access control is another aspect of storage policy 528, defining who can access certain data and what permissions they have, ensuring that sensitive information is only available to authorized users. Additionally, storage policy 528 may include performance requirements for data access speeds and availability, constraining the selection of storage technologies and configurations. Further, cost management addresses the cost implications of storage, including considerations for tiered storage solutions that balance performance and cost.

In some implementations, the storage policy configures the connections between the plurality of storage processors and the initiating back-end storage processor for high-availability. For example, storage policy 528 may define rules and configuration constraints for connections between initiating back-end storage processor 504 and storage processors accessible to initiating back-end storage processor 504 to allow for high-availability. In this example, storage policy 528 provides rules and configuration constraints that ensure that a connection exists between initiating back-end storage processor 504 and storage processors 516, 518 of storage system 406 from multiple connections such that even when a primary connection fails, at least one secondary connection remains to connect initiating back-end storage processor 504 and storage processors 516, 518 of storage system 406.

In some implementations, the storage policy configures the connections between the plurality of storage processor and the initiating back-end storage processor for scaling a number of connections per storage processor. For example, storage policy 528 may define rules and configuration constraints for connections between initiating back-end storage processor 504 and storage processors accessible to initiating back-end storage processor 504 to maximize or scale the number of connections per storage processor. In this example, storage policy 528 provides rules and configuration constraints that provide at least a threshold number of connections between initiating back-end storage processor 504 and storage processors 516, 518 of storage system 406.

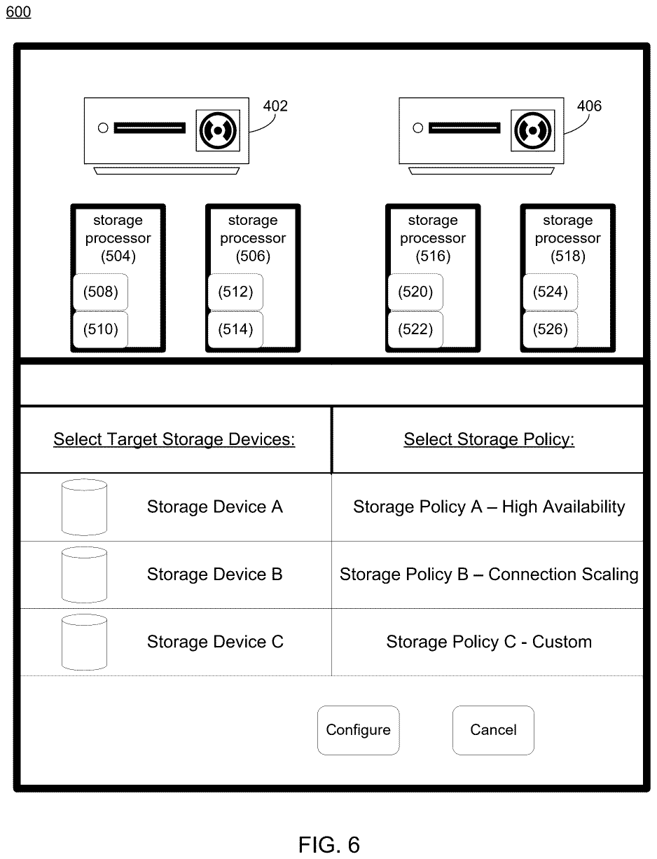

Referring also to FIG. 6, an exemplary graphical user interface (e.g., graphical user interface 600) is shown depicting initiating back-end storage processor 504, a listing of discovered storage processors (e.g., shown in FIG. 6 as “Storage Processor A”; “Storage Processor B”; and “Storage Processor C”), and a listing of potential storage policies (e.g., shown in FIG. 6 as “Storage Policy A—High Availability”; “Storage Policy B—Connection Scaling”; and “Storage Policy C—Custom”). While three examples of storage processors and three examples of storage policies are shown, it will be appreciated that any number of storage processors and storage policies may be provided to a user for receiving a selection of particular storage processors and a particular storage policy within the scope of the present disclosure.

In some implementations, back-end storage fabric management process 10 configures 304 connections between the plurality of storage processors and the initiating back-end storage processor based upon, at least in part, the selected storage policy. For example, using the selected storage policy (e.g., as shown in FIG. 6), back-end storage fabric management process 10 configures 304 connections between initiating back-end storage processor 504 and the plurality of storage processors accessible to initiating back-end storage processor 504 (e.g., storage processors 516, 518 of storage system 406 in the example of FIG. 5). In some implementations, configuring 304 connections includes identifying all possible connections between initiating back-end storage processor 504 and the plurality of storage processors accessible to initiating back-end storage processor 504, and enabling or disabling specific connections from all of the possible connections. In some implementations, back-end storage fabric management process 10 automatically configures 304 the connections by applying the selected storage policy to determine which connections to enable and which connections to disable between initiating back-end storage processor 504 and the plurality of storage processors accessible to initiating back-end storage processor 504.

In some implementations, back-end storage fabric management process 10 configures 304 connections between the plurality of storage processors and the initiating back-end storage processor by determining various properties of the plurality of storage processors accessible to initiating back-end storage processor 504. For example, back-end storage fabric management process 10 may determine the number of connections configured by the user, whether discovered storage processors are different for the initiating back-end storage processor, whether the number of storage processors is greater than the number configured by the user, unique ports for connection from each storage processor, targets belonging to different controllers, and/or an order of connections to the plurality of storage processors (e.g., sequential or random). It will be appreciated that various metrics or properties may be used by back-end storage fabric management process 10 to configure 304 the connections between the plurality of storage processors and the initiating back-end storage processor within the scope of the present disclosure.

In some implementations, configuring 304 the connections between the plurality of storage processors and the initiating back-end storage processor includes configuring 310 connections between the subset of storage processors and the initiating back-end storage processor. For example and as shown in FIG. 6, back-end storage fabric management process 10 provides a user the ability to select a subset of storage processors from the plurality of storage processors that are accessible to initiating back-end storage processor 504 for configuring connections therebetween. In some implementations, back-end storage fabric management process 10 configures 310 connections between the subset of storage processors (e.g., storage processors selected in FIG. 6) and initiating back-end storage processor 504 according to storage policy 528. In this manner, a user can define the scope of storage processors included in the configuration of connections to and/or from initiating back-end storage processor 504.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
discovering a plurality of storage processors connected to a storage fabric that are accessible to an initiating back-end storage processor of a storage system;
processing a selection for a storage policy associated with the plurality of storage processors that are accessible to the initiating back-end storage processor; and
configuring connections between the plurality of storage processors and the initiating back-end storage processor based upon, at least in part, the selected storage policy.

2. The computer-implemented method of claim 1, further comprising:
enabling a user to manage the plurality of storage processors connected to the storage fabric that are accessible to the initiating back-end storage processor.

3. The computer-implemented method of claim 1, further comprising:
processing a selection of a subset of storage processors from the plurality of storage processors.

4. The computer-implemented method of claim 3, wherein configuring the connections between the plurality of storage processors and the initiating back-end storage processor includes configuring connections between the subset of storage processors and the initiating back-end storage processor.

5. The computer implemented method of claim 1, wherein the storage policy configures the connections between the plurality of storage processors and the initiating back-end storage processor for high-availability.

6. The computer implemented method of claim 1, wherein the storage policy configures the connections between the plurality of storage processors and the initiating back-end storage processor for scaling a number of connections per storage processor.

7. The computer implemented method of claim 1, wherein the storage system is a Fibre Channel (FC) Storage Area Network (SAN).

8. A computer program product residing on a non-transitory computer readable medium having a plurality of instructions stored thereon which, when executed by a processor, cause the processor to perform operations comprising:
discovering a plurality of storage processors connected to a storage fabric that are accessible to an initiating back-end storage processor of a storage system;
processing a selection for a storage policy associated with the plurality of storage processors that are accessible to the initiating back-end storage processor; and
configuring connections between the plurality of storage processors and the initiating back-end storage processor based upon, at least in part, the selected storage policy.

9. The computer program product of claim 8, wherein the operations further comprise:
enabling a user to manage the plurality of storage processors connected to the storage fabric that are accessible to the initiating back-end storage processor.

10. The computer program product of claim 8, wherein the operations further comprise:
processing a selection of a subset of storage processors from the plurality of storage processors.

11. The computer program product of claim 10, wherein configuring the connections between the plurality of storage processors and the initiating back-end storage processor includes configuring connections between the subset of storage processors and the initiating back-end storage processor.

12. The computer program product of claim 8, wherein the storage policy configures the connections between the plurality of storage processors and the initiating back-end storage processor for high-availability.

13. The computer program product of claim 8, wherein the storage policy configures the connections between the plurality of storage processors and the initiating back-end storage processor for scaling a number of connections per storage processor.

14. The computer program product of claim 8, wherein the storage system is a Fibre Channel (FC) Storage Area Network (SAN).

15. A computing system comprising:
a memory; and
a processor configured to discover a plurality of storage processors connected to a storage fabric that are accessible to an initiating back-end storage processor of a storage system, to process a selection for a storage policy associated with the plurality of storage processors that are accessible to the initiating back-end storage processor, and to configure connections between the plurality of storage processors and the initiating back-end storage processor based upon, at least in part, the selected storage policy.

16. The computing system of claim 15, wherein the processor is further configured to:
enable a user to manage the plurality of storage processors connected to the storage fabric that are accessible to the initiating back-end storage processor.

17. The computing system of claim 15, wherein the processor is further configured to:
process a selection of a subset of storage processors from the plurality of storage processors.

18. The computing system of claim 16, wherein configuring the connections between the plurality of storage processors and the initiating back-end storage processor includes configuring connections between the subset of storage processors and the initiating back-end storage processor.

19. The computing system of claim 15, wherein the storage policy configures the connections between the plurality of storage processors and the initiating back-end storage processor for high-availability.

20. The computing system of claim 15, wherein the storage policy configures the connections between the plurality of storage processors and the initiating back-end storage processor for scaling a number of connections per storage processor.
